(19) United States
(12) Patent Application Publication
(10) Pub. No.: US 2012/0121867 A1
(43) Pub. Date: May 17, 2012

(54) METAL PLATE MEMBER FOR THE FABRICATION OF A COMPOSITE PLATE MEMBER

(76) Inventor: Chin-Hsing Horng, KUEISHAN HSIANG (TW)

(21) Appl. No.: 12/948,723

(22) Filed: Nov. 17, 2010

(51) Int. Cl. B32B 1/00

(52) U.S. Cl. 428/174

(57) ABSTRACT

A metal plate member for the fabrication of a composite plate member is disclosed having a flat plate body and multiple binding structures located on one side of the flat plate body. Each binding structure includes one or a number of binding strips upwardly curvedly extended from one side of the flat plate body and a binding space defined between each binding strip and the flat plate body. After bonding of one plastic rod member to each binding structure or a second plate member to the flat plate body of the metal plate member, the binding strips of each binding structure provide a multi-directional stop effect to prohibit displacement of the plastic rod members or second plate member relative to the metal plate member.

### BACKGROUND OF THE INVENTION

1. Field of the Invention

The present invention relates to composite plate member fabrication technology and more particularly, to a metal plate member for the fabrication of a composite plate member that has binding strips to provide a multi-directional stop effect to enhance the binding strength between the meta plate member and the bonded plastic posts or second plate member.

2. Description of the Related Art

Following fast development of science and technology, the design concept of commercial electronic products is focused on light, thin, short and small characteristics. Many electronic products (cell phone, notebook, PDA, etc.) are made convenient to carry by user. To enhance mobility, the weight of electronic products must be reduced. In order to reduce the weight, the shell or casing of an electronic product may be formed of an outer metal layer having a relatively thinner wall thickness and an inner plastic layer having a relatively thicker wall thickness. This design greatly reduces the product weight while providing excellent tensile strength. Further, the outer metal layer facilitates surface treatment by an electroplating or coating technique. Therefore, metal is commonly used for the casing or the outer layer of the casing for commercial electronic products.

When setting a plastic plate member in a metal plate member to give a support, an adhesive is usually used to bond the two plate members together. However, this method has drawbacks as follows:

1. After hardened, the volume of the adhesive is slightly reduced (due to vaporization of fluid), and tiny open spaces may exist in between the metal plate member and the plastic plate member, lowering the product yield rate.

2. The metal plate member and the plastic plate member may be twisted when the user opens or closes the electronic product, and the torsional force thus produced may cause separation of the adhesive from the metal plate member and/or the plastic plate member, resulting in plate member separation damage.

3. When bonding the metal plate member and the plastic plate member together, the hardening time of the applied adhesive prolongs the product manufacturing time. Further, the use of the adhesive relatively increases the manufacturing cost of the product, weakening the competitive advantage.

Further, to facilitate installation of electronic components in the casing of an electronic product, the casing may be provided with rod members. The rod members may be affixed to the metal plate members of the casing by a spot soldering technique or by means of the application of an adhesive. However, the application of a spot soldering technique tends to damage the sense of beauty of the surface structure of the metal plate members of the casing. When an adhesive is used to bond rod members to the metal plate members of the casing, it wastes much labor and time and increases the cost, lowering consumers' purchasing desire.

### SUMMARY OF THE INVENTION

The present invention has been accomplished under the circumstances in view. It is the main object of the present invention to provide a metal plate member for the fabrication of a composite plate member, which provides a multi-directional stop effect to enhance the binding strength between the metal plate member and the bonded plastic posts or second plate member.

To achieve this and other objects of the present invention, a metal plate member for the fabrication of a composite plate member comprises a flat plate body and multiple binding structures located on one side of the flat plate body. Each binding structure comprises at least one binding strip upwardly curvedly extended from one side of the flat plate body and a binding space defined between each binding strip and the flat plate body. After bonding of one plastic rod member to each binding structure or a second plate member to the flat plate body of the metal plate member, the binding strips of each binding structure provide a multi-directional stop effect to prohibit displacement of the plastic rod members or second plate member relative to the metal plate member. Further, each binding strip defines with the flat plate body an acute contained angle. Each binding structure further comprises a side rib connected between each of the two distal ends of each binding strip and the flat plate body.

### BRIEF DESCRIPTION OF THE DRAWINGS

FIG. 1 is an oblique elevational view of a part of a metal plate member for the fabrication of a composite plate member in accordance with a first embodiment of the present invention.

FIG. 2 is an oblique elevational view of a part of a metal plate member for the fabrication of a composite plate member in accordance with a second embodiment of the present invention.

FIG. 3 is an oblique elevational view of a part of a metal plate member for the fabrication of a composite plate member in accordance with a third embodiment of the present invention.

FIG. 4 is an oblique elevational view of a part of a metal plate member for the fabrication of a composite plate member in accordance with a fourth embodiment of the present invention.

FIG. 5 is an oblique elevational view of a part of a metal plate member for the fabrication of a composite plate member in accordance with a fifth embodiment of the present invention.

FIG. 6 is an oblique elevational view of a part of a metal plate member for the fabrication of a composite plate member in accordance with a sixth embodiment of the present invention.

FIG. 7 is an oblique elevational view of a part of a metal plate member for the fabrication of a composite plate member in accordance with a seventh embodiment of the present invention.

FIG. 8 is an oblique elevational view of a part of a metal plate member for the fabrication of a composite plate member in accordance with an eighth embodiment of the present invention.

FIG. 9 is an oblique elevational view of a part of a metal plate member for the fabrication of a composite plate member in accordance with a ninth embodiment of the present invention.

FIG. 10 is an oblique elevational view of a part of a metal plate member for the fabrication of a composite plate member in accordance with a tenth embodiment of the present invention.

FIG. 11 is a schematic sectional view illustrating a plastic rod member bonded to the binding structure at the flat plate body of a metal plate member in accordance with the present invention.

FIG. 12 corresponds to FIG. 12, illustrating an alternate form of the plastic rod member.

FIG. 13 is an elevational view of a composite plate member constructed according to the present invention, illustrating different plastic rod members bonded to the binding structures at the flat plate body of the metal plate member.

FIG. 14 is a sectional view of a composite plate member constructed according to the present invention, illustrating the binding structure of the metal plate member embedded in the adhesive in the opening of the attached second plate member.

FIG. 15 is an oblique elevation of the composite plate member shown in FIG. 14.

FIG. 16 is a schematic sectional view of another structure of composite plate member constructed according to the present invention, illustrating a plastic plate member injection-molded on the flat plate body of the metal plate member.

FIG. 17 is an oblique elevation of the composite plate member shown in FIG. 16.

### DETAILED DESCRIPTION OF THE PREFERRED EMBODIMENT

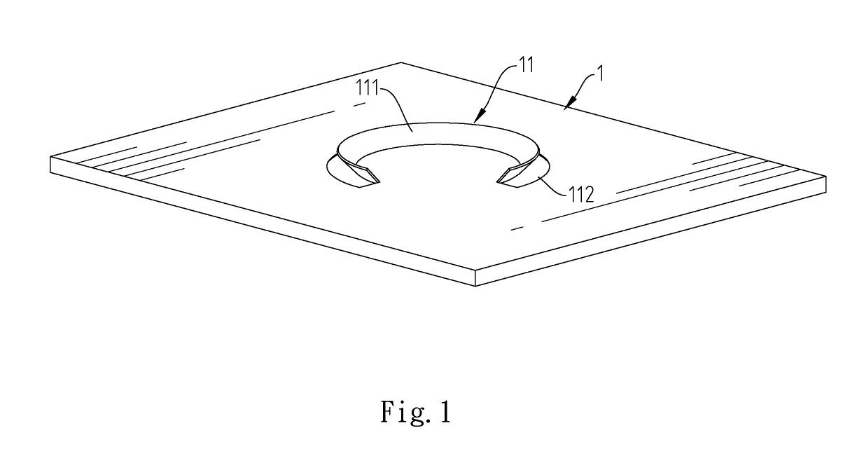

Referring to FIG. 1, a metal plate member for the fabrication of a composite plate member in accordance with a first embodiment of the present invention is shown comprising a flat plate body 1 and a binding structure 11 located on one side of the flat plate body 1. The binding structure 11 comprises a binding strip 111 upwardly curvedly extended from one side of the flat plate body 1 and a binding space 112 defined between the binding strip 111 and the flat plate body 1. Further, the contained angle defined between the binding strip 111 and the flat plate body 1 is an acute angle. The binding strip 111 is formed by means of cutting the selected side of the flat plate body 1 with a machine tool that is operated to drive a cutting tool into the selected side of the flat plate body 1 obliquely to a predetermined depth and then rotating the cutting toll relative to the flat plate body 1 through a predetermined angle.

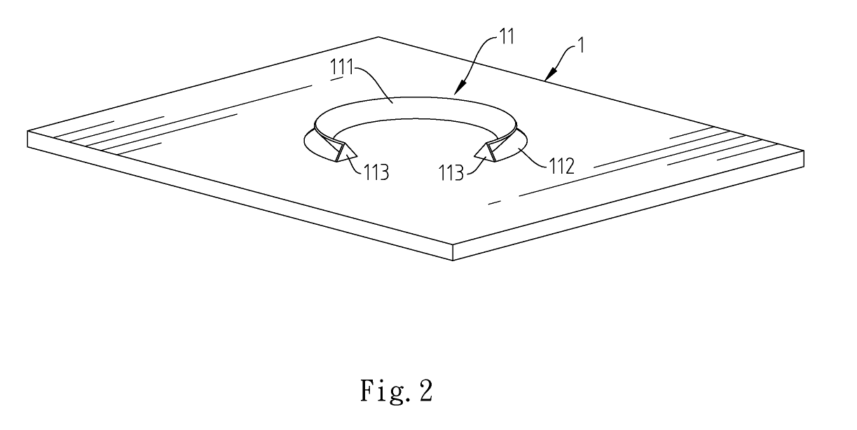

FIG. 2 illustrates a metal plate member for the fabrication of a composite plate member in accordance with a second embodiment of the present invention. This second embodiment is substantially similar to the aforesaid first embodiment with the exception that a side rib 113 is connected between each of the two distal ends of the binding strip 111 and the flat plate body 1 to enhance the tensile strength.

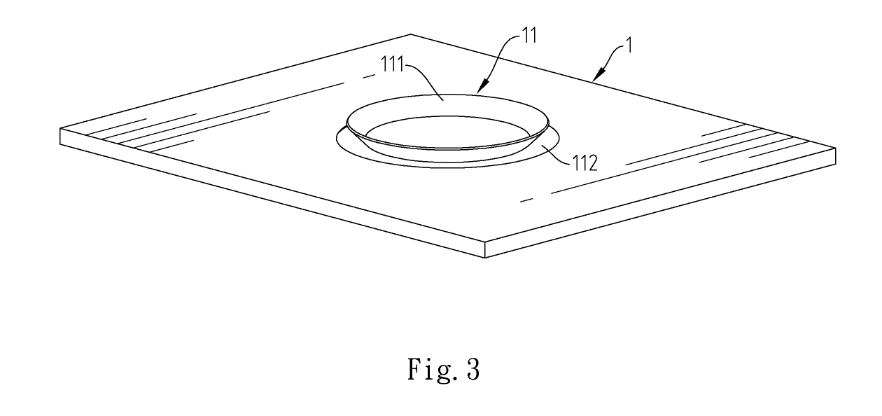

FIG. 3 illustrates a metal plate member for the fabrication of a composite plate member in accordance with a third embodiment of the present invention. This third embodiment is substantially similar to the aforesaid first embodiment with the exception that the binding strip 111 of the metal plate member of this third embodiment has an annular configuration.

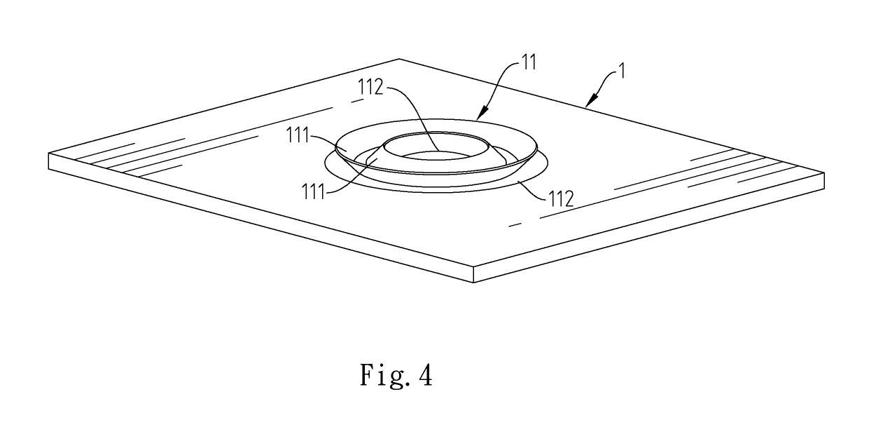

FIG. 4 illustrates a metal plate member for the fabrication of a composite plate member in accordance with a fourth embodiment of the present invention. According to this fourth embodiment, the binding structure 11 comprises two binding strips 111 concentrically located on one side of the flat plate body 1 and binding space 112 defined between each binding strip 111 and the flat plate body 1. Further, the binding strips 111 extend from one side of the flat plate body 1 obliquely in reversed directions.

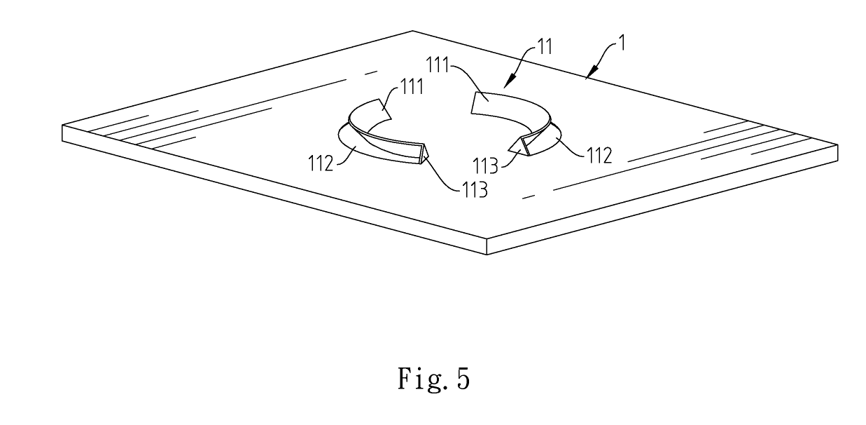

FIG. 5 illustrates a metal plate member for the fabrication of a composite plate member in accordance with a fifth embodiment of the present invention. According to this fifth embodiment, the binding structure 11 comprises two binding strips 111 that are smoothly arched and symmetrically protruded from one side of the flat plate body 1 along a circle, a binding space 112 defined between each binding strip 111 and the flat plate body 1, and a side rib 113 connected between each of the two distal ends of each binding strip 111 and the flat plate body 1 to enhance the tensile strength.

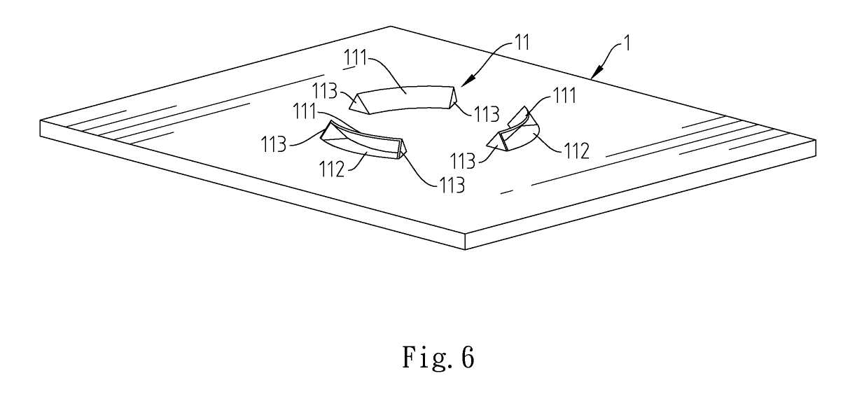

FIG. 6 illustrates a metal plate member for the fabrication of a composite plate member in accordance with a sixth embodiment of the present invention. According to this sixth embodiment, the binding structure 11 comprises three binding strips 111 that are smoothly arched and protruded from one side of the flat plate body 1 and equiangularly spaced along a circle, a binding space 112 defined between each binding strip 111 and the flat plate body 1, and a side rib 113 connected between each of the two distal ends of each binding strip 111 and the flat plate body 1 to enhance the tensile strength.

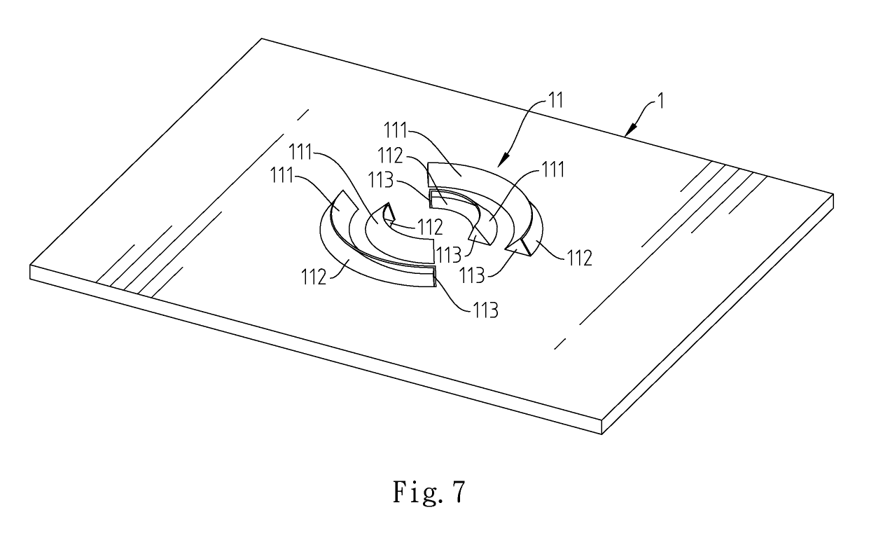

FIG. 7 illustrates a metal plate member for the fabrication of a composite plate member in accordance with a seventh embodiment of the present invention. According to this seventh embodiment, the binding structure 11 comprises a plurality of binding strips 111 that are smoothly arched and protruded from one side of the flat plate body 1 and equiangularly spaced along two concentric circles, a binding space 112 defined between each binding strip 111 and the flat plate body 1, and a side rib 113 connected between each of the two distal ends of each binding strip 111 and the flat plate body 1 to enhance the tensile strength.

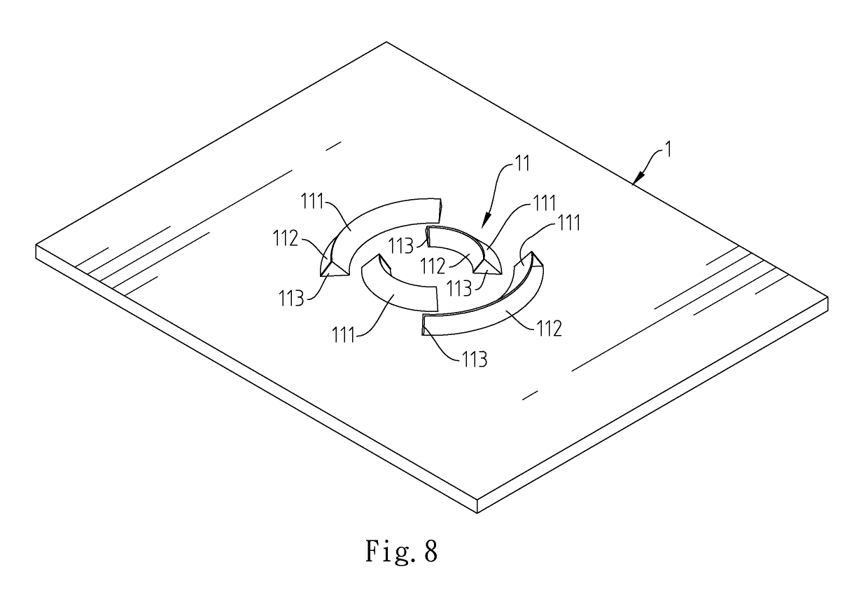

FIG. 8 illustrates a metal plate member for the fabrication of a composite plate member in accordance with an eighth embodiment of the present invention. This eighth embodiment is substantially similar to the aforesaid seventh embodiment with the exception that the two smooth arched binding strips 111 that are spaced along the inner circle are arranged at right angles relative to the two smooth arched binding strips 111 that are spaced along the outer circle.

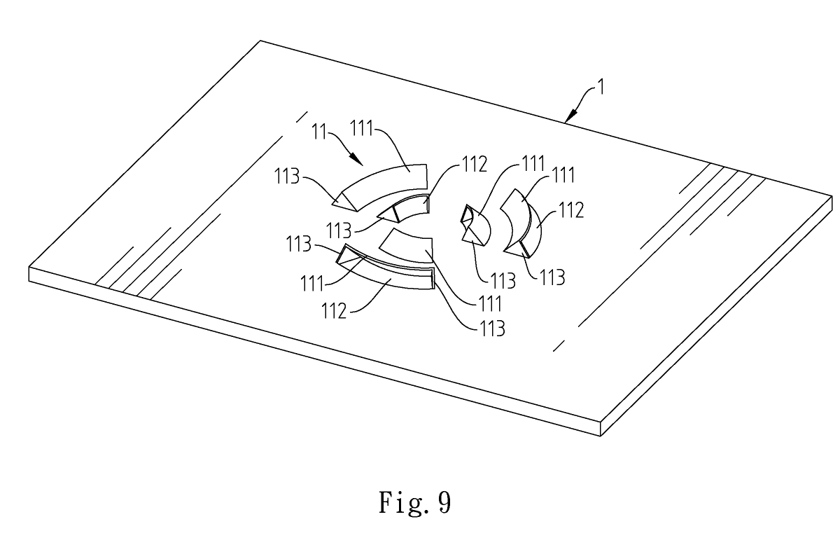

FIG. 9 illustrates a metal plate member for the fabrication of a composite plate member in accordance with a ninth embodiment of the present invention. This ninth embodiment is substantially similar to the aforesaid eighth embodiment with the exception that the number of binding strips 111 that are spaced along each of the two concentric circles. In the eighth embodiment, there are two binding strips 111 spaced along each of the two concentric circles. In the ninth embodiment, there are three binding strips 111 spaced along each of the two concentric circles.

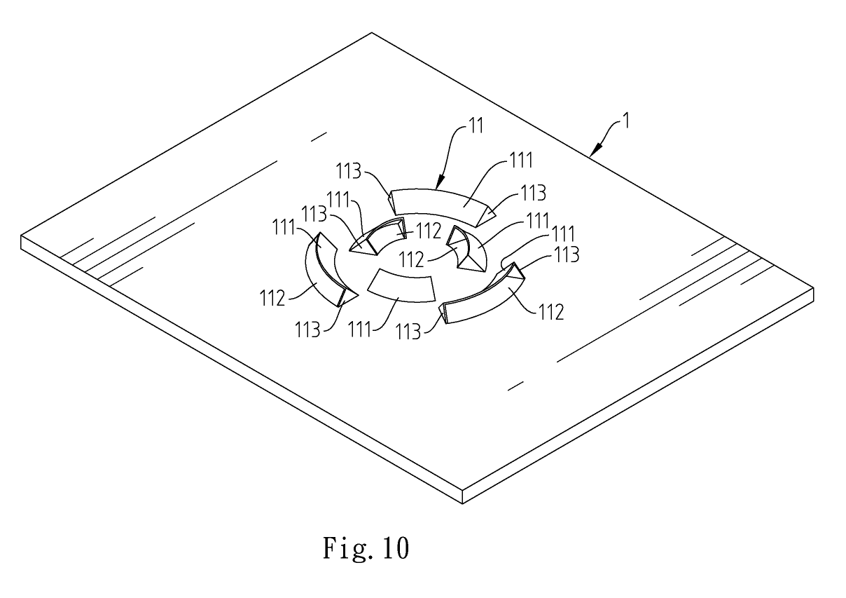

FIG. 10 illustrates a metal plate member for the fabrication of a composite plate member in accordance with a tenth embodiment of the present invention. This tenth embodiment is substantially similar to the aforesaid ninth embodiment with the exception that the angular relationship between the binding strips 111 that are spaced along the inner one of the two concentric circles and the binding strips 111 that are spaced along the outer one of the two concentric circles.

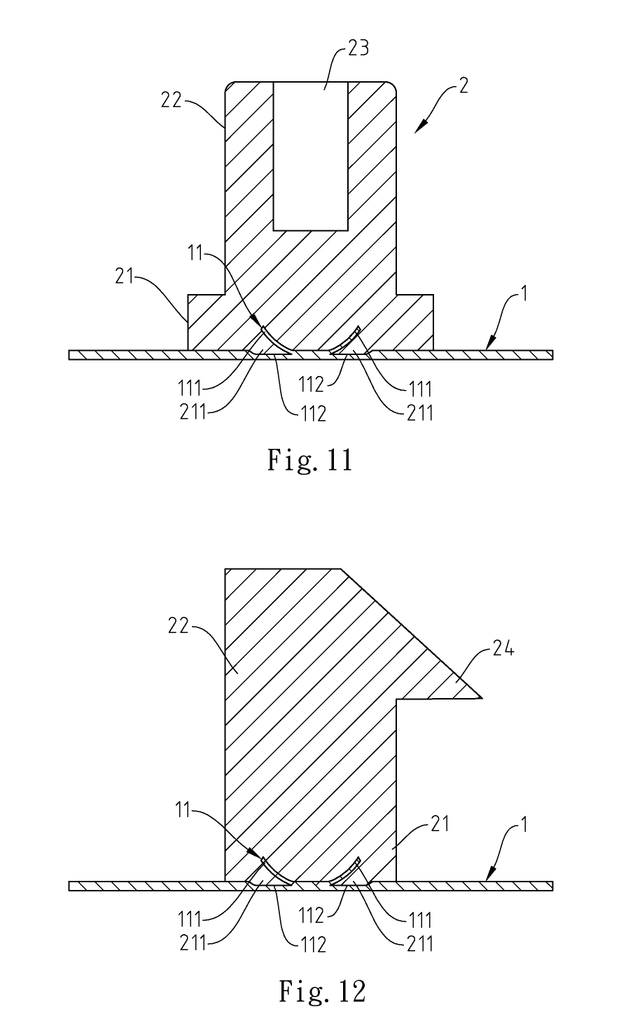

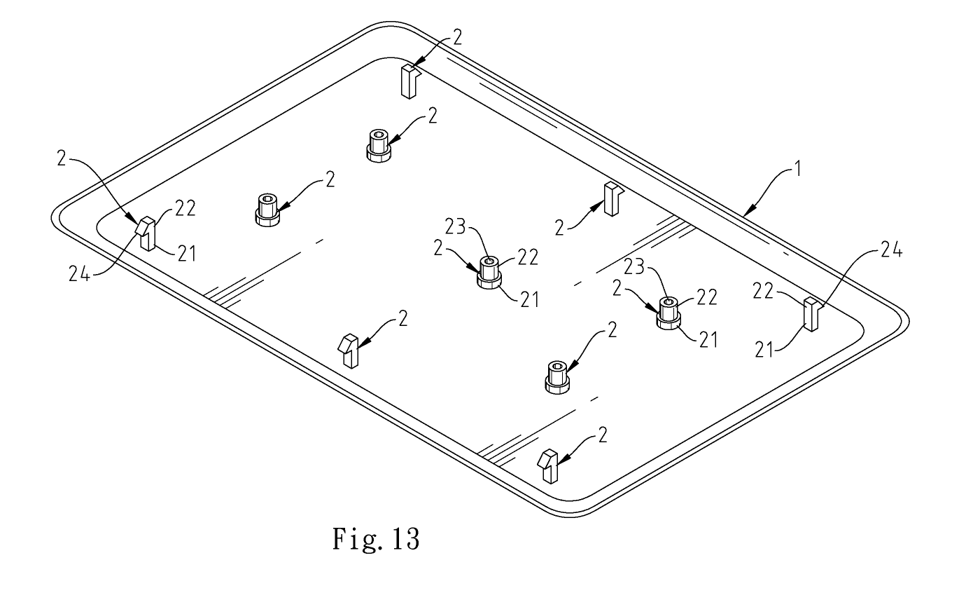

Referring to FIGS. 11˜13 and FIG. 5 again, plastic rod members 2 can be bonded to respective binding structures 11 at the flat plate body 1 by means of insert molding. After bonding of the plastic rod members 2 to the respective binding structures 11, the binding strips 111 of each binding structure 1 are embedded in the respective plastic rod member 2. Further, each plastic rod member 2 comprises a bonding base 21 bonded to the surface of the flat plate body 1, a stop portion 211 extended from the bonding base 21 and engaged in the binding spaces 112 between the binding strips 111 and the flat plate body 1 to provide a multi-directional stop effect and to enhance the binding strength between the respective rod member 2 and the flat plate body 1, a shank 22 perpendicularly extended from the bonding base 21, and a locating hole 23 or hook 24 located on the shank 22 for securing an attached external member.

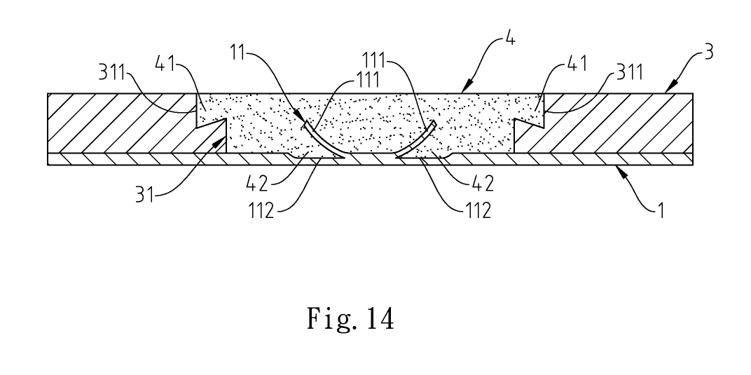

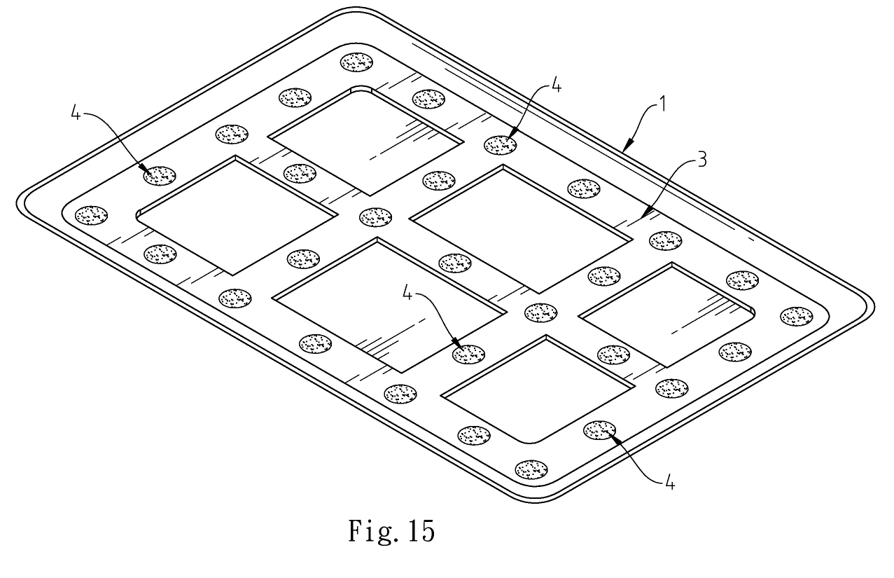

Referring to FIGS. 14 and 15 and FIG. 5 again, a second plate member 3 can be bonded to the flat plate body 1 (of a metal plate member constructed in accordance with the present invention). The second plate member 3 has an opening 31 cut through the top and bottom sides thereof corresponding to each binding structure 1 at the flat plate body 1. The opening 31 has an expanded upper part 311. During bonding, the second plate member 3 is attached to the flat plate body 1 of the metal plate member to let the binding structures 11 of each binding structures 11 be received in one respective opening 31 of the plastic plate member 3, and then an adhesive 4 is applied to each opening 31 and then cured. After cured, the adhesive 4 forms a first stop portion 41 that fills up the expanded upper part 311 of the associating opening 31 to prohibit movement of the second plate member 3 in direction away from the flat plate body 1 of the metal plate member, and a second stop portion 42 that fills up the binding spaces 112 of the associating binding structure 11 to enhance the binding strength between the flat plate body 1 of the metal plate member and the second plate member 3. Further, the adhesive 4 can be a thermosetting plastic adhesive, thermoplastic plastic adhesive or UV light curable adhesive.

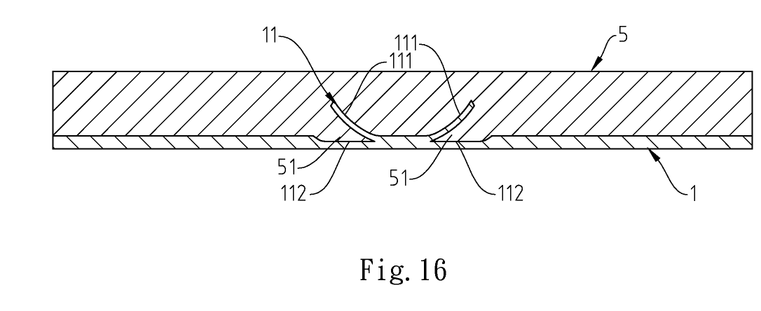

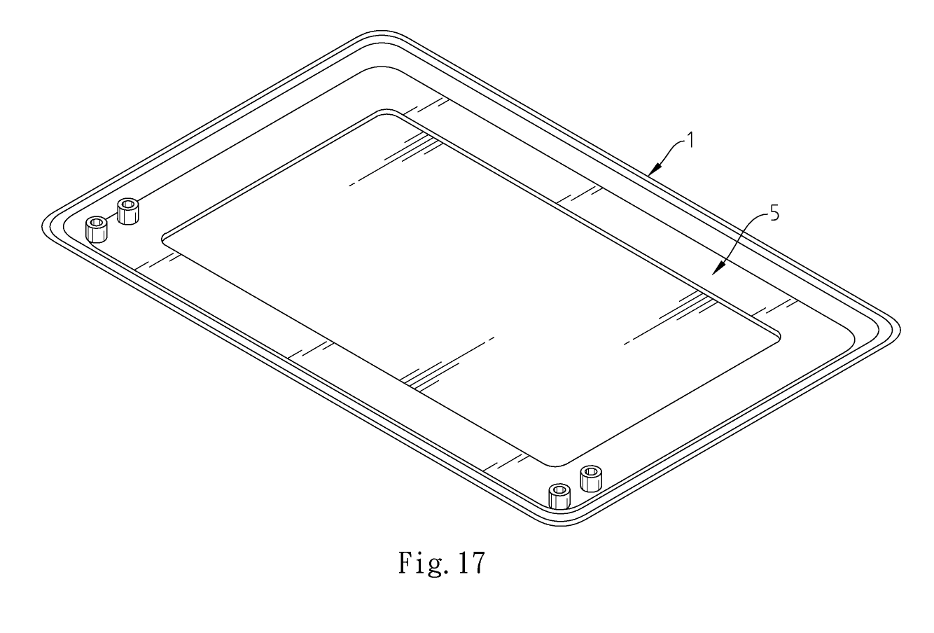

Referring to FIGS. 16 and 17 and FIG. 5 again, a plastic plate member 5 can be formed on one side of the flat plate body 1 (of a metal plate member constructed in accordance with the present invention) by means of injection molding. After formation of the plastic plate member 5 on the flat plate body 1, a part of the plastic plate member 5 forms a stop portion 51 that engages into the binding spaces 112 of each binding structure 11 to provide a multi-directional stop effect, prohibiting displacement of the plastic plate member 5 relative to the flat plate body 1 of the metal plate member and enhancing the binding strength between the plastic plate member 5 and the flat plate body 1 of the metal plate member.

What the invention claimed is:

1. A metal plate member, comprising:
a flat plate body and at least one binding structure located on one side of said flat plate body, each said binding structure comprising at least one binding strip upwardly curvedly extended from one side of said flat plate body and a binding space defined between each said binding strip and said flat plate body.

2. The metal plate member as claimed in claim 1, wherein each said binding strip defines with said flat plate body an acute contained angle.

3. The metal plate member as claimed in claim 1, wherein each said binding structure further comprises a side rib connected between each of the two distal ends of each said binding strip and said flat plate body.

4. The metal plate member as claimed in claim 1, wherein each said binding structure comprises a plurality of binding strips upwardly curvedly extended from one side of said flat plate body and spaced along a circle.

5. The metal plate member as claimed in claim 1, wherein each said binding structure comprises two sets of binding strips upwardly curvedly extended from one side of said flat plate body in two reversed directions and spaced along two concentric circles.

6. The metal plate member as claimed in claim 1, wherein each said binding strip has an annular configuration and defines with said flat plate body an annular binding space.
